(19) United States
(12) Patent Application Publication
(10) Pub. No.: US 2005/0086150 A1
(43) Pub. Date: Apr. 21, 2005

(54) Stock market trading systems creation algorithm

(76) Inventors: Vincent Christian Serpico, Glendale, AZ (US); Matthew John Brunner, Phoenix, AZ (US)

Correspondence Address: Larry Nakamura, 1611 West Seldon Lane, Phoenix, AZ, 85021, US

(21) Appl. No.: 10/652,154

(22) Filed: Dec. 28, 2004

Related U.S. Application Data
(60) Provisional application No. 60/408,491, filed on Sep. 4, 2002.

(51) Int. Cl. G06F 17/60

(52) U.S. Cl. 705/37

(57) ABSTRACT

The invention is an algorithm that creates a technical analysis based trading system for a given market security. The trading system created provides a market trader with signals of when to buy and sell the given security. The algorithm searches for the most profitable indicators by testing them against quantifiable data of the selected security. It also factors in the user's risk management rules or trading style. Each indicator is tested using a series of three filters, each filter increasing in complexity. As an indicator fails filter one or filter two, it is deemed unprofitable and discarded from the search. This filtering approach allows a computer to perform a smart exhaustive search, using brains and not just brawn. Performing this type of search, the algorithm comes to the same conclusion as a normal exhaustive search, but uses much less computer processing time and power.

### BACKGROUND OF THE INVENTION:

This invention relates to the creation of stock market trading systems, specifically those that use technical indicators. A trading system for equity markets, tells an investor when to buy or sell a specific security (e.g. General Electric Company or Gold Futures). Technical indicators are mathematical formulas based on quantifiable data of a security, such as historical price, volatility or volume, to name a few. These indicators provide signals of when to buy and sell a security. This invention creates a trading system by analyzing technical indicators against a security, and choosing those that are most profitable.

Typically an investor chooses a trading system by testing a few technical indicators against a market security. This may or may not produce a profitable result. A good investor will also apply risk-management rules along with the technical indicators to decide when to buy and sell. Risk-management rules tell an investor when to enter or exit a trade based on a percentage gain or loss, price movement, or other technical signals. With over dozens of technical indicators to choose from, a computer program is needed to test a majority of technical indicators (in a timely manner) to see which are profitable.

There are many computer programs that create trading systems. These programs use all different types of algorithms to do this. There are few if any such programs that test all or a majority of technical indicators against the historical data of a security. This is because the number of combinations of all the technical indicators and all their different parameters, ranges in the millions. The computer processing time needed to test all these combinations would take days or weeks, even on the highest powered computer hardware of today.

Due to the enormous amount of time required to perform an exhaustive search, other programs or algorithms that create similar trading systems do not perform an exhaustive search of technical indicators. These other programs might use a genetic algorithm that performs a near optimal search. A near optimal search will use ‘evolutionary shortcuts’ to obtain a result that is close, but not exact, to the desired result. An example of such a search might return a four if you're looking for a five in a set of numbers. Thus a near, but not optimal, result is returned.

### BRIEF SUMMARY OF THE INVENTION

This invention is a computer algorithm that searches equity market technical indicators, applying them to a chosen security's quantifiable data. The object of this search is to create a trading system for that security by finding the optimal (most profitable) indicators. It performs a ‘logical’ exhaustive search, and saves a lot of time. This is because it searches in a way similar to how a human would perform a search. As previously mentioned, a computer program can waste a lot of time in an exhaustive search. This is because a computer, unlike a human, does not ‘intuitively’ know if the process by which a result is to be obtained is flawed early on in the search.

As an example, let's examine the scenario one might perform when choosing which movie to bring the family. Among five movies to choose, an exhaustive search would require one to view each movie, in its entirety, evaluating the movie based on predetermined criteria. A ‘logical’ exhaustive search would evaluate each movie through a series of filters, each successively more comprehensive than the last. The first filter may examine the movie rating, thus eliminating two of the five prospective films. The second, more comprehensive filter may require one to evaluate the overall appeal of the film by reading its synopsis, actors, writers and directors, thus eliminating one of the three remaining candidates. The third and most comprehensive filter would require one to view the trailers from the two remaining films. Thus, we have performed a ‘logical’ exhaustive search of the five potential films and have significantly reduced our evaluation period. This is a very simple example of the approach this invention takes when searching for its results.

### DRAWINGS

FIG. 1 is a flow chart showing the entire algorithm that creates a trading system by performing an exhaustive search of a set of technical indicators.

FIG. 2 is a flow chart showing the algorithm that creates a list of optimal buy and sell points for any given chart for a security.

### REFERENCE NUMERALS

10 algorithm that obtains optimal entry/exit points on a set of historical stock data
12 loop in algorithm that processes all technical indicators
14 algorithm that checks if a technical indicator accurately reflects the optimal points
16 algorithm that checks if a technical indicator produces a profitable result
18 algorithm that applies risk management rules with a technical indicator looking for profitable result
20 List of profitable technical indicators (trading system)
22 List of rejected technical indicators
200 Inputs into algorithm, the points on a chart, it's median and standard deviation, and the determined trend of the chart.
202 loop in algorithm that processes all points on the chart
204 test if algorithm has established a current best buy/sell points
206 test to find out if the chart is cyclical or not
208 creation of a set of points S that fall 1 and ½ standard deviations away from the chart's median.
210 choose the first point in set S as the current best buy/sell point
212 choose the first point in the chart as the current best buy/sell point
214 test if the next point in the chart is higher/lower by 1 and ½ standard deviations than the current best buy/sell point
216 Mark the current point in the loop processing as the new best buy/sell point, and add the current best buy/sell point to the optimal buy/sell points list
218 Move on to the next point in the chart (loop processing)
220 Picture of a security's chart with optimal buy/sell points encircled
222 Cartesian graph showing a security's chart to determine chart trend

### DETAILED DESCRIPTION

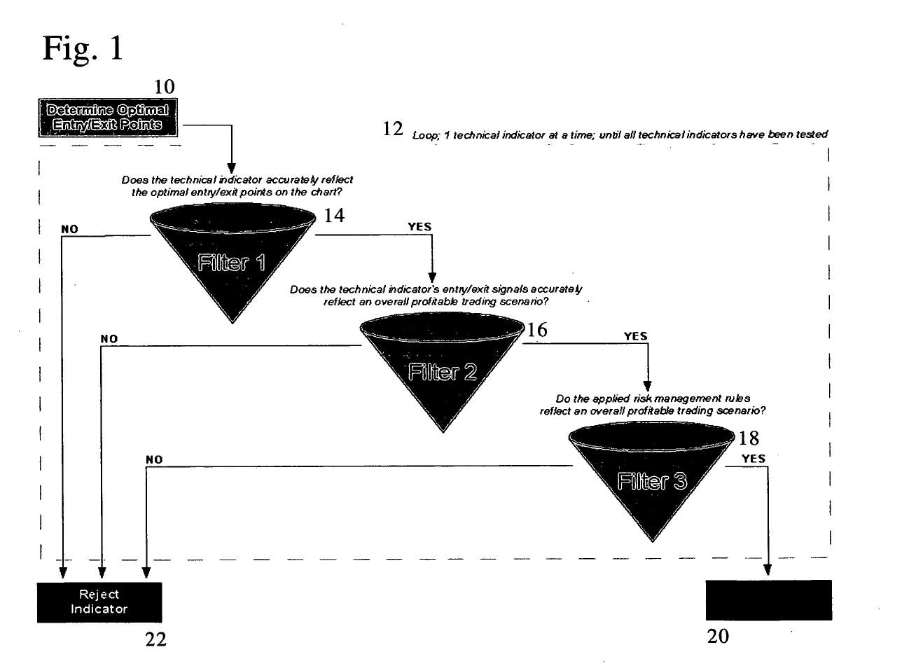

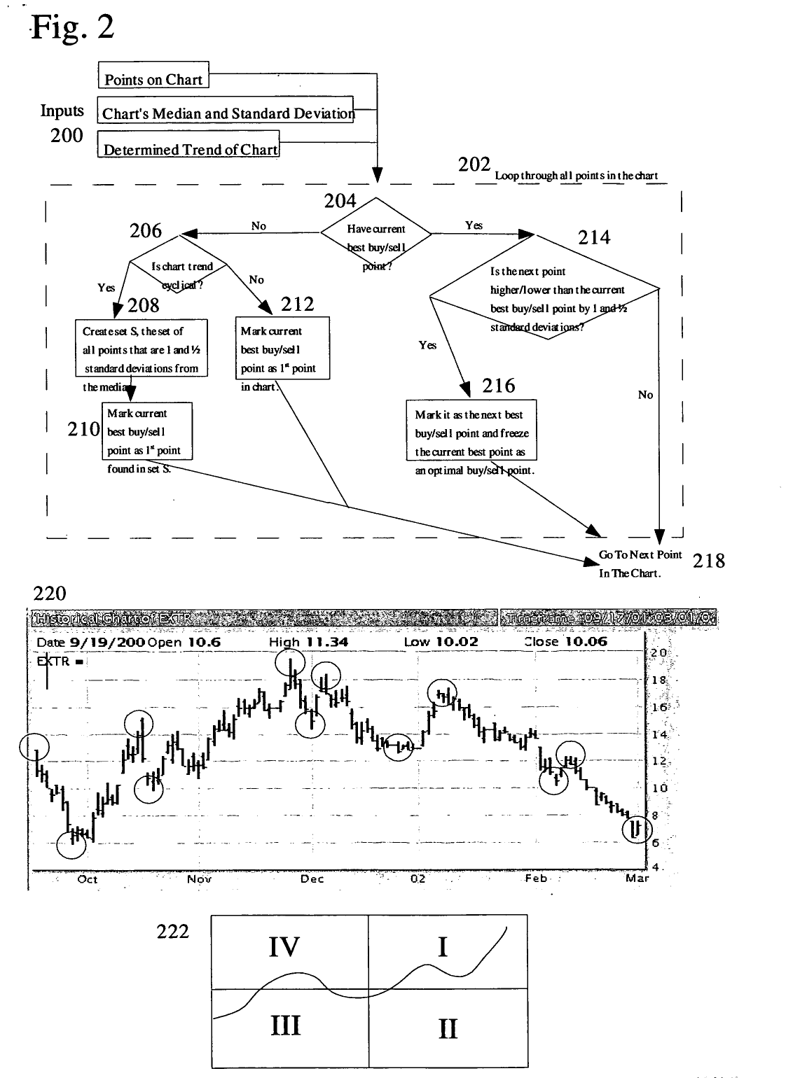

FIG. 1 is a flow chart of an algorithm whose result 20 is a stock market trading system based on technical indicators. To produce this result multiple steps are taken by the algorithm. The first step is another algorithm 10 (shown in FIG. 2) that finds the optimal buy and sell points for a set of historical data for a security. A looping mechanism 12 is used to test all technical indicators. The second step is an algorithm 14 that compares signals from a technical indicator against the optimal buy and sell points produced in 10. If the comparison is bad the technical indicator is rejected 22 and the next indicator is processed through the loop. If the comparison in algorithm 14 is good, that same indicator moves on to step three. Step three is an algorithm 16 which calculates a percentage of money gained or lost if trades were executed from the technical indicator's signals. If algorithm 16 produces a loss then the indicator is rejected 22 and the next indicator is processed through the loop. If algorithm 16 produces a profit, then the indicator is moved on to step four. Step four is an algorithm 18 that re-simulates the trades made in algorithm 16, but also applies risk-management rules. This algorithm 18 calculates a new percentage of money gained or lost. If algorithm 18 produces a loss, then the indicator is rejected 22 and the next indicator is processed through the loop. If algorithm 18 produces a profit, then the indicator is added to the trading system 20.

FIG. 2 is a flow chart of an algorithm whose result is a set of optimal buy and sell points for a given chart of security prices. The inputs 200 are the points on the security's chart, the chart's calculated median and standard deviation, and the trend of the chart whether it be up, down or cyclical. The chart's trend is determined by the Cartesian graph 222 and how many of the security's data points fall in each quadrant. A looping construct 202 is used to test each point in the chart's dataset. The first step 204 is deciding if a current best buy/sell point has been determined. If not, the chart is checked for it's trend 206. If the chart is cyclical, a set of data points S is attained 208 by taking all the points that fall 1 and ½ standard deviations and greater from the median. The current best buy/sell point is marked as the first point, chronologically in set S 210. If the chart is not cyclical, the current best buy/sell point is marked as the first point in the chart. From this point we go to the next point in the chart 218. When the loop starts and we have a current best buy/sell point established 204, a test is done to see if the next point in the chart is higher or lower (depending on current trend) than the current best buy/sell point by 1 and ½ standard deviations 214. If this test fails, we go on to the next point in the dataset 218. If test 214 passes, the point gets marked as the new best buy/sell point, and the current best buy/sell point is added to the result set of optimal buy/sell points 216. Then we move on to the next point in the chart 218.

Operation

In operation the algorithm operates on a set of historical data for a security. The other input to the algorithm is a set of technical indicators. The algorithm's first step 10 is to scan the historical data and choose the best times to buy and sell. These are referred to as the optimal entry and exit points. These are determined by deciding the trend of the chart being processed. The trend is determined using the Cartesian graph 222. This graph divides the points on the security's chart into four quadrants as labeled I, II, III and IV. The chart is determined to have a downtrend if a majority of the points are in quadrants II and IV. The chart is determined to have an uptrend if a majority of the points are in quadrants III and I. The chart is determined to be cyclical if the points are scattered about all four quadrants. Once the chart's trend is determined, algorithm 10 processes each point chronologically in the chart. A series of tests 204, 206, 208, 210, 212, 214, 216 are done on each point as algorithm 10 looks to obtain the optimal buy and sell points on the given security's chart. If the point in the chart passes test 214 and moves into state 216, that point is added to the list of optimal buy and sell points. These are the points at which trades should be made to maximize profit when trading the given security.

The algorithm's second step is to loop through all the technical indicators and filter out those that produce a loss, from those that produce a profit. The technical indicators that produce a profit are kept and become the output of the algorithm, or, a trading system 20. The second step of filtering out the bad technical indicators and keeping the good ones is done via three filters 14, 16 and 18. Any indicators rejected by the filters are set aside 22. Any time an indicator is rejected, loop processing is aborted and the next indicator is processed through the loop. Operation of these three filters 14, 16 and 18 is described next.

The first filter 14 tests the technical indicator against the historical data to see if the signals the indicator produces match the optimal entry and exit points. To do this, each signal the indicator produces is compared in time (chronologically) and in price against a similar point from the optimal exit and entry list. If the indicator produces signals that match 75% or greater of the optimal points, then it passes this filter 14.

The second filter 16 tests the technical indicator's signals by simulating trades against the historical data set. The process enters and exits trades based on technical indicator signals. The result is a percentage gain or loss based on the cumulative trades. If the result of the trades is profitable throughout the historical data set, then the indicator passes this filter 16.

The third filter 18 tests a set of risk-management rules in combination with the trades simulated by the technical indicator. This is done the same way as the second filter 16, except the risk-management rules will most likely produce extra trades throughout the historical data set. An example of a set of risk management rules may dictate a user take 30% of realized profits every 5% gain in equity price. Then a trade for 30% of the shares will be executed when the price rises 5% above the buying price. If the result of these extra trades in combination with technical indicator's signals is profitable, then the indicator passes this filter 18.

All indicators that pass the third filter 18 are added to a list 20 which is the trading system. A trading system consists of the top X number of technical indicators that pass all three filters (14, 16 and 18). The user of the program will choose the number X before processing starts, and the most profitable technical indicators will be used. At this point the algorithm has created a stock market trading system.

1. An algorithm, whose result is a stock market trading system based on technical indicators, comprising:
an algorithm that determines optimal entry/exit points on a set of historical data for a security,
a user defined X number of technical indicators desired,
a looping construct used to test each technical indicator to find the most profitable across the same set of historical data for a security which processes,
testing how accurately the signals a technical indicator produces match against the optimal entry/exit points,
testing how profitable an indicator is based on the entry/exit signals it gives when processed against that same set of historical data for a security,
testing how profitable an indicator is when a set of risk management rules are applied in conjunction with the entry/exit signals the indicator gives when processed against that same set of historical data for a security,
such that most profitable X number of technical indicators that are processed through said looping construct become the stock market trading system.

2. The algorithm recited in claim 1 wherein optimal entry/exit points are determined, comprising:
an algorithm that determines the trend(up, down or cyclical) of a set of historical data for a security,
the following inputs; the set of historical data for a security, the median and standard deviation of said dataset, and the determined trend of said dataset,
a looping construct used to process all data points in the said dataset which processes,
a test determining if the first optimal entry/exit point should be the first point in said dataset, or if it should be the first point from set S(the set of all dataset points that are one and one-half standard deviations away from the dataset median),
a test determining if the current dataset point is an optimal entry/exit point,
a test to see if the next chronological dataset point is higher or lower than the current optimal entry/exit point by one and one-half standard deviations of the dataset,
such that a running list of optimal entry/exit points is kept as these points are determined.

3. The algorithm recited in claim 2 wherein the trend of the set of historical data for a security is determined, comprising:
the graph/charted representation of the set of historical data for a security,
two midpoint lines drawn on said graph; one line top to bottom dividing the graph into two equal sides(left and right), and one line left to right such that said graph gets divided into four equal quadrants,
said quadrants are numbered one to four in clockwise fashion starting with the upper-right hand quadrant,
a count of all data points in each of the four quadrants from said set of historical data for a security,
such that a majority of said data points falling in quadrants one and three determine that the trend is an up trend,
or such that a majority of said data points falling in quadrants two and four determine that the trend is an down trend,
otherwise and equal scattering of said data points will determine that the trend is cyclical.
